(19) United States
(12) Patent Application Publication
(10) Pub. No.: US 2025/0028142 A1
(43) Pub. Date: Jan. 23, 2025

(54) LENS DEVICE AND MANUFACTURING METHOD OF LENS DEVICE

(71) Applicant: FUJIFILM Corporation, Tokyo (JP)

(72) Inventor: Yukihiro KANEKO, Saitama (JP)

(73) Assignee: FUJIFILM Corporation, Tokyo (JP)

(21) Appl. No.: 18/748,070

(22) Filed: Jun. 19, 2024

(30) Foreign Application Priority Data
Jul. 20, 2023 (JP) 2023-118655

(51) Int. Cl. G02B 7/02; G02B 27/00; G02B 27/32

(52) U.S. Cl. CPC G02B 7/023; G02B 7/022; G02B 27/0025; G02B 27/32

(57) ABSTRACT

A lens device includes a fixation frame and a lens frame that holds lenses and that is fixed to the fixation frame. The fixation frame includes a plurality of engagement portions that are arranged in a direction around an optical axis. The lens frame includes an engagement target portion that is selectively engaged with the plurality of engagement portions.

### CROSS-REFERENCE TO RELATED APPLICATIONS

This application claims priority under 35 USC 119 from Japanese Patent Application No. 2023-118655 filed on Jul. 20, 2023, the disclosure of which is incorporated by reference herein.

### BACKGROUND OF THE INVENTION

### 1. Field of the Invention

The present disclosed technology relates to a lens device and a manufacturing method of a lens device.

### 2. Description of the Related Art

Disclosed in JP2014-048434A is a lens barrel including a holding frame that holds one or a plurality of optical elements, a lens barrel member that includes an attachment portion to which the holding frame is attached, and an adjustment member that is disposed between the holding frame and the attachment portion in an optical axis direction of the lens barrel member and that can adjust at least one of the orientation of an optical axis of the optical element or the position of the optical element in the optical axis direction. At least one of the holding frame, the lens barrel member, or the adjustment member has such a shape that a portion of the adjustment member is exposed on an object side or an image side.

Disclosed in JP2016-004233A is a lens including a plurality of lens chambers that hold lens components, and a lens barrel that accommodates the lens chambers. The lens chambers have the same outer diameter as each other, and a window portion through which outer peripheral surfaces of the lens chambers are exposed is formed in the lens barrel. With a force applied to the outer peripheral surfaces of the lens chambers exposed through the window portion, the lens chambers are brought into contact with positioning members that extend to be parallel with a central axis of the lens barrel.

Disclosed in JP2000-066075A is an optical system including a plurality of optical members. The optical system is provided with a plurality of holding members that support the plurality of optical members at a plurality of support points, and the rotation angle of at least one of the plurality of holding members is adjusted such that a residual aberration of the optical system caused by deformation of the plurality of optical members occurring between the plurality of support points is reduced.

### SUMMARY OF THE INVENTION

One embodiment according to the present disclosed technology provides a lens device and a manufacturing method of a lens device, with which it is possible to efficiently change optical characteristics related to a lens.

A first aspect according to the present disclosed technology provides a lens device including a fixation frame and a lens frame that holds lenses and that is fixed to the fixation frame. The fixation frame includes a plurality of engagement portions that are arranged in a direction around an optical axis, and the lens frame includes an engagement target portion that is selectively engaged with the plurality of engagement portions.

A second aspect according to the present disclosed technology provides the lens device according to the first aspect, in which a rotation angle of the lens frame with respect to the fixation frame is changeable by changing which one of the plurality of engagement portions is to be engaged with the engagement target portion.

A third aspect according to the present disclosed technology provides the lens device according to the second aspect, in which optical characteristics of the lenses are changeable by changing the rotation angle.

A fourth aspect according to the present disclosed technology provides the lens device according to the third aspect, in which the optical characteristics include a characteristic related to astigmatism of the lenses.

A fifth aspect according to the present disclosed technology provides the lens device according to any one of the first to fourth aspects, in which the lenses include a lens that is a part of a plurality of lenses of the lens device and that is disposed on an object side.

A sixth aspect according to the present disclosed technology provides the lens device according to any one of the first to fifth aspects, in which the plurality of engagement portions are arranged at four or more and sixteen or less equidistant positions in the direction around the optical axis.

A seventh aspect according to the present disclosed technology provides the lens device according to the sixth aspect, in which the plurality of engagement portions are arranged at eight equidistant positions.

An eighth aspect according to the present disclosed technology provides the lens device according to any one of the first to seventh aspects, in which the number of the engagement target portions is smaller than the number of the plurality of engagement portions.

A ninth aspect according to the present disclosed technology provides the lens device according to any one of the first to eighth aspects, in which the number of the engagement target portions is one.

A tenth aspect according to the present disclosed technology provides the lens device according to any one of the first to ninth aspects, in which the fixation frame includes an identification portion for identification of a position of engagement between the engagement target portion and the engagement portions.

An eleventh aspect according to the present disclosed technology provides the lens device according to the tenth aspect, in which a plurality of the identification portions include symbols arranged in the direction around the optical axis.

A twelfth aspect according to the present disclosed technology provides the lens device according to the tenth or eleventh aspect, in which a plurality of the identification portions are provided on a side surface portion of the fixation frame.

A thirteenth aspect according to the present disclosed technology provides the lens device according to any one of the first to twelfth aspects, in which the fixation frame includes a fixation portion to which the lens frame is fixed, and the plurality of engagement portions are formed at the fixation portion.

A fourteenth aspect according to the present disclosed technology provides the lens device according to the thirteenth aspect, in which the fixation portion is provided at an end portion of the fixation frame that is on one side in an axial direction of the fixation frame.

A fifteenth aspect according to the present disclosed technology provides the lens device according to any one of the first to fourteenth aspects, in which each of the engagement portions is a recess portion, and the engagement target portion is a protrusion portion.

A sixteenth aspect according to the present disclosed technology provides the lens device according to the fifteenth aspect, in which the recess portion is formed in a recessed shape that is open on a radially inner side with respect to the fixation frame.

A seventeenth aspect according to the present disclosed technology provides the lens device according to the fifteenth or sixteenth aspect, in which the protrusion portion is formed in a protruding shape that protrudes toward a radially outer side with respect to the lens frame.

An eighteenth aspect according to the present disclosed technology provides the lens device according to any one of the fifteenth to seventeenth aspects, in which the recess portion is open on one side in an axial direction of the fixation frame.

A nineteenth aspect according to the present disclosed technology provides the lens device according to any one of the fifteenth to eighteenth aspects, in which the protrusion portion is formed on an outer peripheral portion of the lens frame.

A twentieth aspect according to the present disclosed technology provides the lens device according to any one of the fifteenth to nineteenth aspects, in which the lens frame includes a rib that is provided to be adjacent to the protrusion portion in an optical axis direction.

A twenty-first aspect according to the present disclosed technology provides the lens device according to any one of the first to twentieth aspects, in which the fixation frame includes a connection portion, and the lens frame includes a connection target portion that is connected to the connection portion.

A twenty-second aspect according to the present disclosed technology provides a manufacturing method of the lens device according to any one of the first to twentieth aspects, the manufacturing method including a changing step of changing a rotation angle of the lens frame with respect to the fixation frame by changing which one of the plurality of engagement portions is to be engaged with the engagement target portion.

A twenty-third aspect according to the present disclosed technology provides the manufacturing method of the lens device according to the twenty-second aspect, in which the fixation frame includes an identification portion for identification of a position of engagement between the engagement portions and the engagement target portion, and one of a plurality of the identification portions that corresponds to a target rotation angle is extracted in the changing step.

### BRIEF DESCRIPTION OF THE DRAWINGS

FIG. 1 is a perspective view of an imaging apparatus including a lens device according to an embodiment of the present disclosure.

FIG. 2 is a perspective view showing the configuration of a portion of the lens device in an assembled state.

FIG. 3 is a perspective view showing the configuration of a portion of the lens device in a disassembled state.

FIG. 4 is a front view of a fixation frame provided in the lens device as seen from an object side.

FIG. 5 is a front view of a lens frame provided in the lens device as seen from the object side.

FIG. 6 is a perspective view of a fixation frame.

FIG. 7 is a five-view drawing of the fixation frame.

FIG. 8 is an enlarged perspective view of a main part of a peripheral portion of a protrusion portion of the lens frame.

FIG. 9 is a flowchart showing the flow of a manufacturing method of the lens device.

FIG. 10 is a block diagram showing a manufacturing apparatus for the lens device.

FIG. 11 is a diagram showing a hardware configuration of a computer that is applied to the manufacturing apparatus.

### DESCRIPTION OF THE PREFERRED EMBODIMENTS

First, the configuration of an imaging apparatus 10 according to an embodiment of the present disclosure will be described.

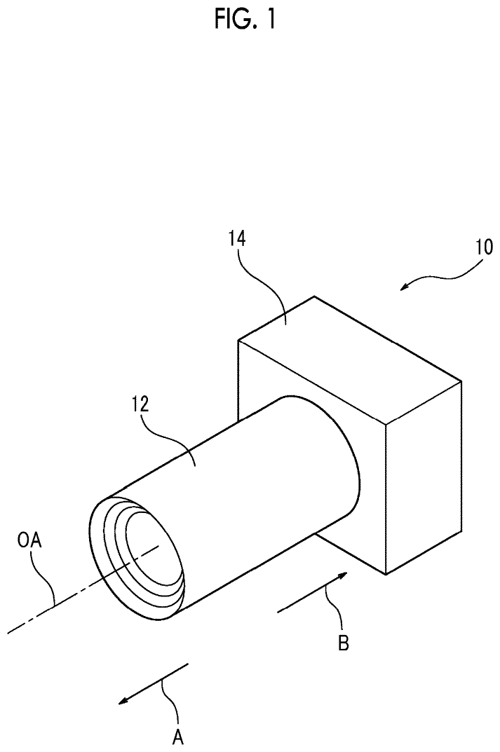

FIG. 1 is a perspective view of an imaging apparatus 10 according to the present embodiment. As shown in FIG. 1, the imaging apparatus 10 includes a lens device 12 and an imaging apparatus body 14. The lens device 12 is provided at a front portion of the imaging apparatus body 14. In FIG. 1, the lens device 12 and the imaging apparatus body 14 are schematically shown. An image sensor (not shown), a computer (not shown), and the like are built into the imaging apparatus body 14. Regarding the lens device 12, an arrow A side is an object side, and an arrow B side is an image formation side. An optical axis OA is an optical axis of the lens device 12. Hereinafter, an axial direction along the optical axis OA will be referred to as an “optical axis direction”. In addition, a direction around the optical axis OA, which is centered on the optical axis OA, will be referred to as a “direction around the optical axis”.

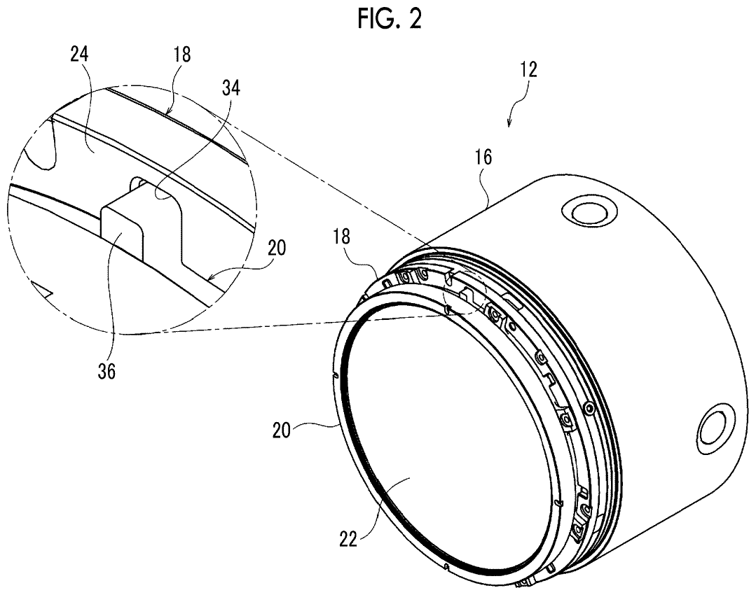

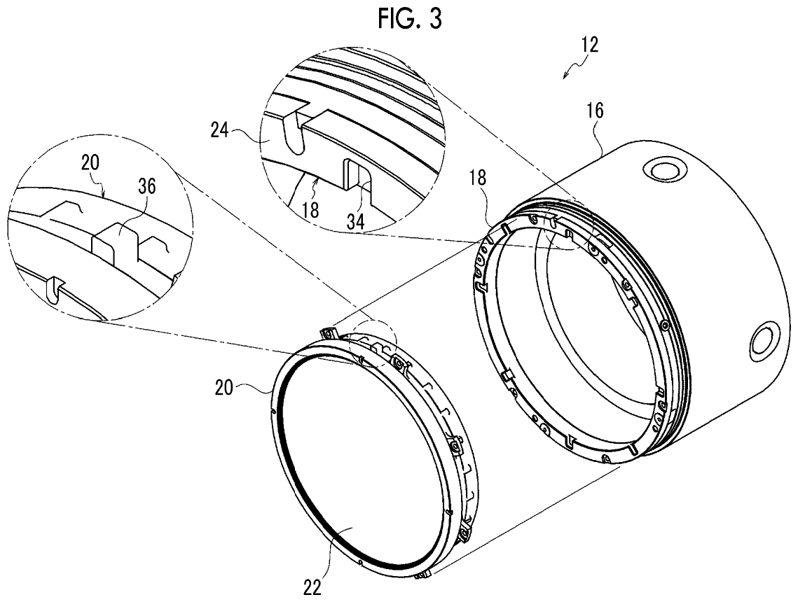

FIG. 2 is a perspective view showing the configuration of a portion of the lens device 12 in an assembled state. FIG. 3 is a perspective view showing the configuration of a portion of the lens device 12 in a disassembled state. As shown in FIGS. 2 and 3, the lens device 12 includes a lens barrel 16, a fixation frame 18, a lens frame 20, and a lens 22.

Each of the lens barrel 16 and the fixation frame 18 is formed in a cylindrical shape. The term “a cylindrical shape” used herein refers to a cylindrical shape that has an uneven portion and/or an opening or the like at an inner peripheral portion and/or an outer peripheral portion. The lens barrel 16 is provided radially outside the fixation frame 18. The lens frame 20 is formed in an annular shape. The term “an annular shape” used herein refers to an annular shape that has an uneven portion and/or an opening or the like at an inner peripheral portion and/or an outer peripheral portion. The lens 22 is provided radially inside the lens frame 20. The lens 22 is held by the lens frame 20.

The lens 22 is, for example, an objective lens. The lens device 12 includes other lenses (not shown) in addition to the lens 22. Hereinafter, the lens 22 and the other lenses will be referred to as a plurality of lenses. The plurality of lenses are disposed to be arranged in the optical axis direction. The lens 22 may be any one of a first group of lenses that is a part of the plurality of lenses and that is disposed on the object side.

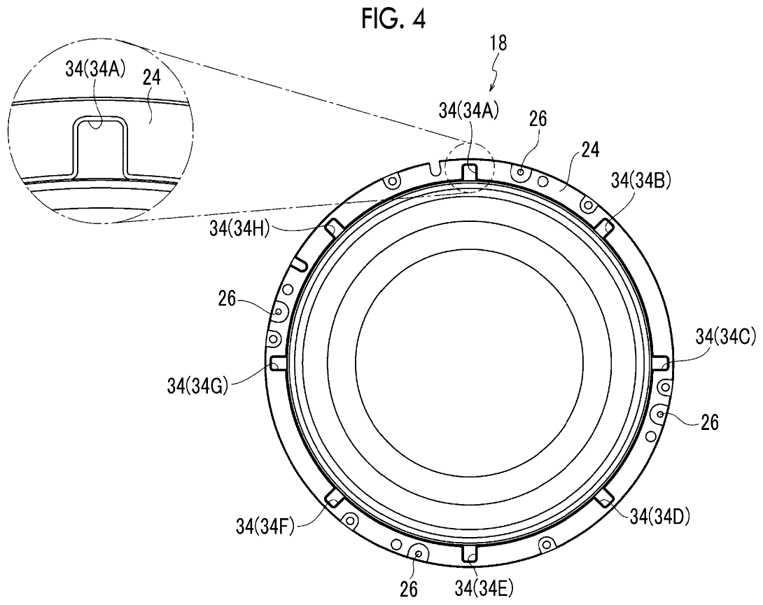

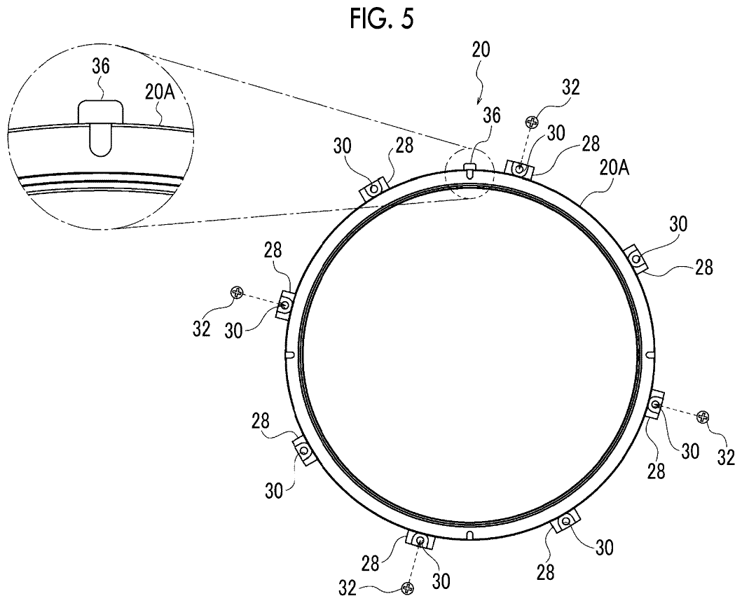

FIG. 4 is a front view of the fixation frame 18 as seen from the object side. FIG. 5 is a front view of the lens frame 20 as seen from the object side. As shown in FIGS. 4 and 5, the fixation frame 18 includes a fixation portion 24 for fixation of the lens frame 20 (refer to FIG. 3 as well). The fixation portion 24 is provided at an object-side end portion of the fixation frame 18. The object-side end portion of the fixation frame 18 is an example of “an end portion of a fixation frame that is on one side in an axial direction” in the present disclosed technology. The fixation portion 24 is formed in an annular shape along an outer peripheral portion of the fixation frame 18.

The fixation frame 18 includes a plurality of screw holes 26. The plurality of screw holes 26 are formed in the fixation portion 24. The plurality of screw holes 26 are arranged in the direction around the optical axis. For example, the plurality of screw holes 26 are arranged at equal intervals in the direction around the optical axis. The number of the plurality of screw holes 26 is, for example, four. Each screw hole 26 is formed along the optical axis direction and is open on the object side with respect to the fixation frame 18. The screw hole 26 is an example of a “connection portion” in the present disclosed technology.

The lens frame 20 includes a plurality of flanges 28. The plurality of flanges 28 are formed on an outer peripheral portion 20A of the lens frame 20. The plurality of flanges 28 are arranged in the direction around the optical axis. For example, the plurality of flanges 28 are arranged at equal intervals in the direction around the optical axis. The number of the plurality of flanges 28 is, for example, eight. Each flange 28 extends toward a radially outer side with respect to the lens frame 20 from the outer peripheral portion 20A of the lens frame 20. In each flange 28, a through-hole 30 penetrating the flange 28 in the optical axis direction is formed. The flange 28 is an example of a “connection target portion” in the present disclosed technology.

As will be described below, the rotation angle of the lens frame 20 with respect to the fixation frame 18 can be changed in increments of 45 degrees. In addition, the lens frame 20 is fixed to the fixation frame 18 at a rotation angle determined in accordance with the optical characteristics of the lens 22. The flanges 28, the screw holes 26, and screws 32 are used to fix the lens frame 20 to the fixation frame 18. That is, shaft portions of the screws 32 are inserted into the respective through-holes 30 of the flanges 28 and the shaft portions of the screws 32 are screwed into the screw holes 26 so that the lens frame 20 is fixed to the fixation frame 18. The fixation frame 18 includes a plurality of recess portions 34. The plurality of recess portions 34 are an example of “a plurality of engagement portions” in the present disclosed technology. The plurality of recess portions 34 are formed at the fixation portion 24. The plurality of recess portions 34 are arranged in the direction around the optical axis. For example, the plurality of recess portions 34 are arranged at equal intervals in the direction around the optical axis. The number of the plurality of recess portions 34 is, for example, eight. Each recess portion 34 is formed in a recessed shape that is open on a radially inner side with respect to the fixation frame 18. In addition, each recess portion 34 is open on the object side with respect to the fixation frame 18. The object side with respect to the fixation frame 18 is an example of “one side in an axial direction of a fixation frame” in the present disclosed technology.

Hereinafter, in a case where it is necessary to distinguish between the eight recess portions 34, each of the eight recess portions 34 will be referred to “a recess portion 34A”, “a recess portion 34B”, “a recess portion 34C”, “a recess portion 34D”, “a recess portion 34E”, “a recess portion 34F”, “a recess portion 34G”, or “a recess portion 34H”.

The lens frame 20 includes a protrusion portion 36. The protrusion portion 36 is an example of “an engagement target portion” in the present disclosed technology. The number of the protrusion portions 36 formed at the lens frame 20 is one. The protrusion portion 36 is formed at an outer peripheral portion 20A of the lens frame 20. The protrusion portion 36 is formed in a protruding shape that protrudes toward a radially outer side with respect to the lens frame 20 from the outer peripheral portion 20A.

The protrusion portion 36 is selectively engaged with the plurality of recess portions 34 in accordance with the rotation angle of the lens frame 20 with respect to the fixation frame 18. In other words, it is possible to change the rotation angle of the lens frame 20 with respect to the fixation frame 18 by changing which one of the plurality of recess portions 34 is to be engaged with the protrusion portion 36.

That is, the rotation angle of the lens frame 20 is set to “0°” in a case where the protrusion portion 36 is engaged with the recess portion 34A, the rotation angle of the lens frame 20 is set to “45°” in a case where the protrusion portion 36 is engaged with the recess portion 34B, the rotation angle of the lens frame 20 is set to “90°” in a case where the protrusion portion 36 is engaged with the recess portion 34C, and the rotation angle of the lens frame 20 is set to “135°” in a case where the protrusion portion 36 is engaged with the recess portion 34D.

That is, the rotation angle of the lens frame 20 is set to “180°” in a case where the protrusion portion 36 is engaged with the recess portion 34E, the rotation angle of the lens frame 20 is set to “225°” in a case where the protrusion portion 36 is engaged with the recess portion 34F, the rotation angle of the lens frame 20 is set to “270°” in a case where the protrusion portion 36 is engaged with the recess portion 34G, and the rotation angle of the lens frame 20 is set to “315°” in a case where the protrusion portion 36 is engaged with the recess portion 34H.

It is possible to change the optical characteristics of the lens 22 by changing the rotation angle of the lens frame 20. The optical characteristics referred to herein include, for example, a characteristic related to astigmatism of the lens 22. The astigmatism refers to an aberration in which meridional light rays and sagittal light rays, which are light rays from one point off the optical axis, are different from each other in focal length with respect to the lens 22. Examples of the characteristic related to the astigmatism of the lens 22 include image formation performance affected by the astigmatism of the lens 22. In the present embodiment, for example, an object is to suppress a decrease in image formation performance caused by the astigmatism of the lens 22.

Although the detailed description will be omitted, according to the Zernike polynomials, the astigmatism of the lens 22 is expressed at pitches of 45° in a circumferential direction of the lens 22. Therefore, by changing the rotation angle of the lens frame 20 in increments of 45°, it is possible to suppress the decrease in image formation performance caused by the astigmatism of the lens 22. In addition, since the rotation angle of the lens frame 20 can be changed in increments of 45°, for example, it is possible to efficiently suppress a decrease in image formation performance in comparison with a configuration in which the rotation angle of the lens frame 20 can be continuously changed as desired (that is, a configuration in which the rotation angle can be changed in a non-stepwise manner).

Note that, since the protrusion portion 36 is selectively engaged with the plurality of recess portions 34, each of the flange 28 is disposed at a corresponding to any one of the plurality of screw holes 26 regardless of which angle the rotation angle of the lens frame 20 is changed to. That is, by causing the shaft portions of the screws 32 to penetrate the through-holes 30 and screwing the shaft portions of the screws 32 into the screw holes 26, it is possible to fix the lens frame 20 to the fixation frame 18 in a state where the rotation angle of the lens frame 20 is maintained.

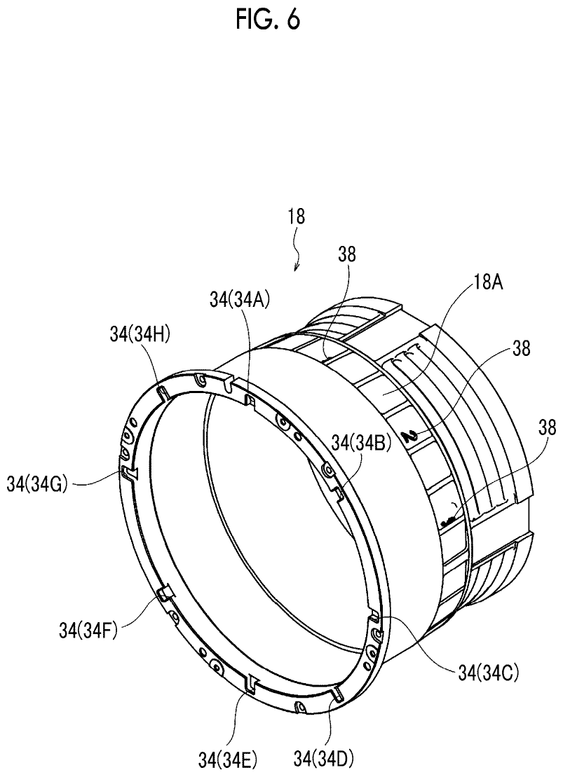

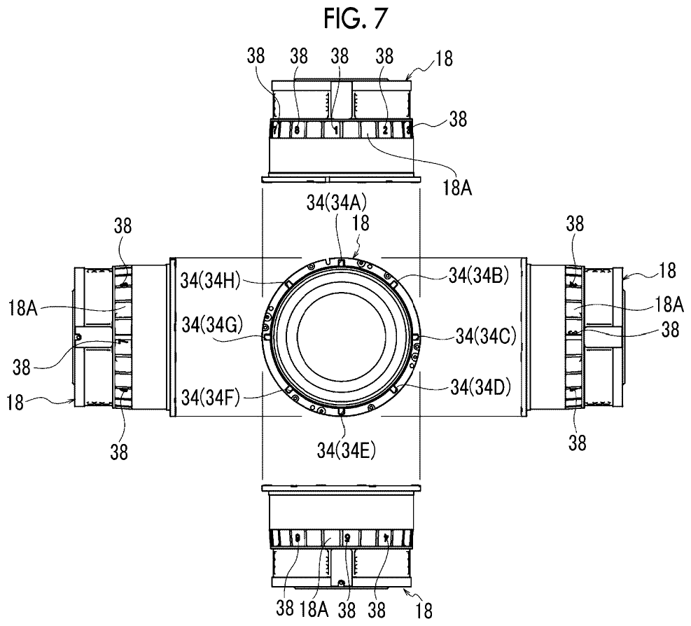

FIG. 6 is a perspective view of the fixation frame 18. FIG. 7 is a five-view drawing of the fixation frame 18. As shown in FIGS. 6 and 7, the fixation frame 18 includes a plurality of identification portions 38. Each identification portion 38 is used to identify the position of engagement between the protrusion portion 36 and the recess portions 34, and is provided at a position corresponding to each recess portion 34. The number of the plurality of identification portions 38 corresponds to the number of the plurality of recess portions 34. The plurality of identification portions 38 are, for example, a plurality of numbers. The plurality of numbers are, for example, 1 to 8.

For example, a number “1” corresponds to the recess portion 34A, a number “2” corresponds to the recess portion 34B, a number “3” corresponds to the recess portion 34C, a number “4” corresponds to the recess portion 34D, a number “5” corresponds to the recess portion 34E, a number “6” corresponds to the recess portion 34F, a number “7” corresponds to the recess portion 34G, and a number “8” corresponds to the recess portion 34H. The numbers “1” to “8” are examples of “a symbol” in the present disclosed technology.

The plurality of identification portions 38 are provided on a side surface portion 18A (that is, the outer peripheral portion) of the fixation frame 18. The plurality of identification portions 38 can be seen from the radially outer side with respect to the fixation frame 18. The numbers “1” to “8” are arranged in ascending order in the direction around the optical axis. Note that instead of the numbers “1” to “8”, symbols (that is, symbols other than numbers) for identification of the position of engagement between the protrusion portion 36 and the recess portions 34 may also be adopted. The symbols may be alphabets “A to H”.

By using the plurality of identification portions 38, it is possible to engage the protrusion portion 36 with the recess portion 34 corresponding to the rotation angle of the lens frame 20. For example, in a case where it is necessary to set the rotation angle of the lens frame 20 to “0°”, the protrusion portion 36 may be engaged with the recess portion 34A corresponding to the number “1”. In addition, in a case where it is necessary to set the rotation angle of the lens frame 20 to “45°”, the protrusion portion 36 may be engaged with the recess portion 34B corresponding to the number “2”. In addition, in a case where it is necessary to set the rotation angle of the lens frame 20 to “90°”, the protrusion portion 36 may be engaged with the recess portion 34C corresponding to the number “3”. In addition, in a case where it is necessary to set the rotation angle of the lens frame 20 to “135°”, the protrusion portion 36 may be engaged with the recess portion 34D corresponding to the number “4”.

In addition, in a case where it is necessary to set the rotation angle of the lens frame 20 to “180°”, the protrusion portion 36 may be engaged with the recess portion 34E corresponding to the number “5”. In addition, in a case where it is necessary to set the rotation angle of the lens frame 20 to “225°”, the protrusion portion 36 may be engaged with the recess portion 34F corresponding to the number “6”. In addition, in a case where it is necessary to set the rotation angle of the lens frame 20 to “270°”, the protrusion portion 36 may be engaged with the recess portion 34G corresponding to the number “7”. In addition, in a case where it is necessary to set the rotation angle of the lens frame 20 to “315°”, the protrusion portion 36 may be engaged with the recess portion 34H corresponding to the number “8”.

Therefore, for example, in a case where an operation of changing the rotation angle of the lens frame 20 is to be performed by a worker, it is preferable to give the worker an instruction regarding any of the numbers “1” to “8” corresponding to the rotation angle of the lens frame 20 than to give the worker a specific instruction regarding the rotation angle of the lens frame 20, in terms of reducing the number of mistakes and improving the work efficiency for the worker.

In addition, the plurality of identification portions 38 are provided on the side surface portion 18A of the fixation frame 18. Here, for example, in a case where the plurality of identification portions 38 are provided on an object-side end surface of the fixation portion 24, the plurality of identification portions 38 may be hidden by the lens frame 20 in a case where the lens frame 20 is fixed to the fixation portion 24. With regard to this, in a case where the plurality of identification portions 38 are provided on the side surface portion 18A of the fixation frame 18, it is possible to prevent the plurality of identification portions 38 from being hidden by the lens frame 20, so that workability can be ensured.

Note that although the lens barrel 16 is provided radially outside the fixation frame 18, the lens barrel 16 may be assembled with the fixation frame 18 after the rotation angle of the lens frame 20 is changed. Meanwhile, in a case where the lens barrel 16 is assembled with the fixation frame 18 before the rotation angle of the lens frame 20 is changed, the position of the lens barrel 16 may be shifted such that the plurality of identification portions 38 are made visible in a case where the rotation angle of the lens frame 20 is to be changed.

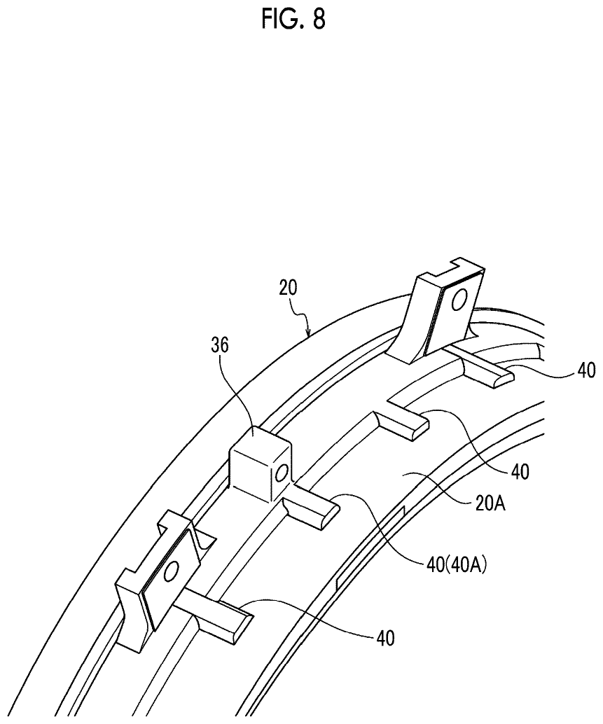

FIG. 8 is an enlarged perspective view of a main part of a peripheral portion of the protrusion portion 36 of the lens frame 20. The lens frame 20 includes a plurality of ribs 40. The plurality of ribs 40 are formed on the outer peripheral portion 20A of the lens frame 20. The plurality of ribs 40 are arranged in the direction around the optical axis. The plurality of ribs 40 are formed on an image formation side with respect to the protrusion portion 36. A rib 40A, which is one of the plurality of ribs 40, is formed at a position corresponding to the protrusion portion 36 and may be connected to the protrusion portion 36 in the optical axis direction.

In a case where the rib 40A is provided to be adjacent to the protrusion portion 36 in the optical axis direction, the rib 40A can reinforce the protrusion portion 36. In addition, in a case where the lens frame 20 is molded by using a mold, the rib 40A and the protrusion portion 36 can be pulled out from the mold in one direction, so that the moldability of the lens frame 20 can be improved in comparison with a case where the rib 40A and the protrusion portion 36 are offset from each other in the direction around the optical axis.

Next, a manufacturing method of the lens device 12 according to the present embodiment will be described.

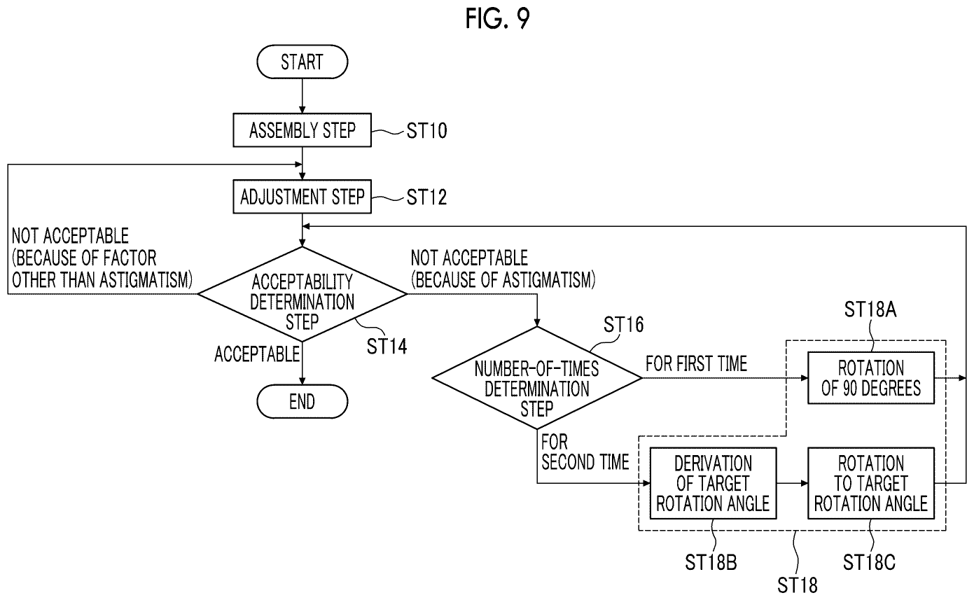

FIG. 9 is a flowchart showing the flow of a manufacturing method of the lens device 12 according to the present embodiment. As shown in FIG. 9, the manufacturing method of the lens device 12 according to the present embodiment includes an assembly step, an adjustment step, an acceptability determination step, a number-of-times determination step, and a changing step.

In an assembly step ST10, the lens device 12 is assembled by using a plurality of components including the lens barrel 16, the fixation frame 18, the lens frame 20, and a plurality of lenses.

An adjustment step ST12 is executed after the assembly step. In the adjustment step ST12, the position of at least any one of the plurality of lenses including the lens 22 is adjusted in a direction intersecting the optical axis and/or the optical axis direction.

An acceptability determination step ST14 is executed after the adjustment step ST12. In the acceptability determination step ST14, light is incident on the lens device 12 and an image is formed by light transmitted through the lens device 12. Then, acceptability determination related to an image plane formed by the light is performed. In the acceptability determination related to the image plane, for example, whether the image plane is acceptable, the image plane is not acceptable because of a factor other than astigmatism of the lens 22, or the image plane is not acceptable because of astigmatism of the lens 22 is determined by means of pattern matching or the like, based on the state of an image.

In a case where it is determined that the image plane is acceptable in the acceptability determination step ST14, the manufacturing method of the lens device 12 ends. Meanwhile, in a case where it is determined that the image plane is not acceptable because of a factor other than astigmatism of the lens 22 in the acceptability determination step ST14, the adjustment step ST12 is executed again. In addition, in a case where it is determined that the image plane is not acceptable because of astigmatism of the lens 22 in the acceptability determination step ST14, the process proceeds to a number-of-times determination step ST16.

In the number-of-times determination step ST16, it is determined whether it has been determined that the image plane is not acceptable because of astigmatism of the lens 22 in the acceptability determination step ST14 for the first time or the second time.

A changing step ST18 is executed after the number-of-times determination step ST16. In the changing step ST18, the process proceeds to a first rotation step ST18A in a case where it has been determined that the image plane is not acceptable for the first time. Then, in the first rotation step ST18A, the lens frame 20 is rotated by 90° from the current position. For example, in a case where the current rotation angle of the lens frame 20 is “0°”, the protrusion portion 36 is engaged with the recess portion 34C such that the rotation angle is changed to “90°”. Since astigmatism is a function in increments of 180° and the rotation angle pitch of the lens frame 20 is set to 45°, an angle by which the lens frame 20 is rotated in the first rotation step ST18A is set to 90° so that an image formation performance improvement effect is obtained most with respect to the current position.

Meanwhile, in a case where it has been determined that the image plane is not acceptable for the second time, in the changing step ST18, the process proceeds to a derivation step ST18B and a rotation angle (hereinafter, will be referred to as a target rotation angle”) at which the aberration angle of the fixation frame 18 and the aberration angle of the lens frame 20 are orthogonal to each other is derived. The aberration angle of the fixation frame 18 refers to the angle of a direction axis of astigmatism caused by the fixation frame 18. In addition, the aberration angle of the lens frame 20 refers to the angle of a direction axis of astigmatism caused by the lens frame 20. Although the detailed description thereof will be omitted, the aberration angle of the fixation frame 18 and the aberration angle of the lens frame 20 are specified by using a test device.

The target rotation angle may be derived by means of pattern matching or the like or may be derived by means of a calculation expression or the like, based on the state of an image obtained in the acceptability determination step. Then, the process proceeds to a second rotation step ST18C, and the rotation angle of the lens frame 20 is changed based on the target rotation angle. For example, in a case where the current rotation angle of the lens frame 20 is “90°” and the target rotation angle is “135°”, the protrusion portion 36 is engaged with the recess portion 34D such that the rotation angle is changed to “135°”.

Note that in the changing step, the rotation angle of the lens frame 20 is changed after the screws 32 are removed from the respective screw holes 26. In addition, after the rotation angle of the lens frame 20 is changed, the shaft portions of the screws 32 are inserted into the through-holes 30 of the respective flanges 28, and the shaft portions of the screws 32 are screwed into the screw holes 26 so that the lens frame 20 is fixed to the fixation frame 18.

After the changing step, the process returns to the acceptability determination step. Since the changing step is executed after the adjustment step, in the acceptability determination step executed after the rotation angle of the lens frame 20 is changed, the acceptability determination can be performed in a state where there is no influence of the positions of the plurality of lenses (that is, in a state where the plurality of lenses are set at prescribed positions).

Note that, usually, in a case where a target rotation angle is derived with respect to the second non-acceptance and the rotation angle of the lens frame 20 is changed based on the target rotation angle, it is determined that the image plane is acceptable in the acceptability determination step executed for the third time. However, in a case where it is determined that the image plane is not acceptable again in the acceptability determination step executed for the third time, abnormality notification may be performed.

In addition, for example, in a case where the rotation angles of the lens frame 20 at which it is determined that the image plane is acceptable in the acceptability determination step show a certain tendency regarding the lens devices 12 manufactured in the same lot, the lens frame 20 may be assembled with the fixation frame 18 at the rotation angle of the certain tendency in the assembly step. For example, in a case where there is a tendency that it is determined that the image plane is acceptable in the acceptability determination step in a case where the rotation angle is “45°”, the rotation angle may be set to “45°” in the assembly step. In this case, the number of times that it is determined that the image plane is not acceptable in the acceptability determination step can be reduced in comparison with a case where a default rotation angle is adopted regardless of a tendency related to the rotation angle.

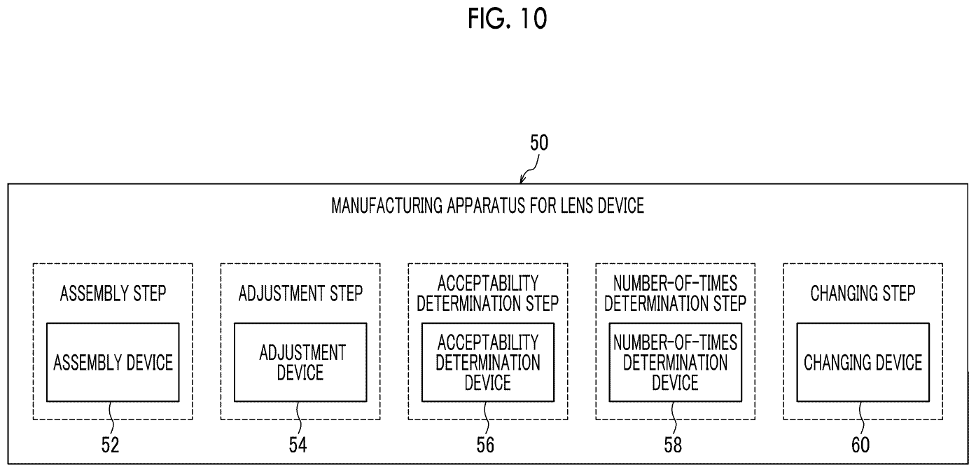

FIG. 10 is a block diagram showing a manufacturing apparatus 50 that manufactures the lens device 12. The manufacturing apparatus 50 is an apparatus that realizes the above-described manufacturing method of the lens device 12, and includes an assembly device 52, an adjustment device 54, an acceptability determination device 56, a number-of-times determination device 58, and a changing device 60.

The assembly device 52 is a device that executes the assembly step. The assembly device 52 may include a jig, a transport device, an assembly robot, or the like as a device for assembly of the lens device 12. The assembly device 52 may perform the entire assembly work or the assembly device 52 and a worker may perform the assembly work in cooperation with each other.

The adjustment device 54 is a device that executes the adjustment step. The adjustment device 54 may include a jig, a transport device, an adjustment robot, or the like as a device for adjustment of the positions of the plurality of lenses including the lens 22 in the direction intersecting the optical axis and/or in the optical axis direction. The adjustment device 54 may perform the entire adjustment work or the adjustment device 54 and a worker may perform the adjustment work in cooperation with each other.

The acceptability determination device 56 is a device that executes the acceptability determination step. The acceptability determination device 56 may include, as devices for acceptability determination related to an image plane on which an image is formed by light transmitted through the lens device 12, a light source that causes light to be incident on the lens device 12, a camera that images an image plane on which an image is formed by light, and a computer performs acceptability determination based on an image output from the camera. The acceptability determination device 56 may perform the entire determination work, or the acceptability determination device 56 and a worker may perform the determination work in cooperation with each other. For example, an image output from the camera may be displayed on a display so that the worker performs acceptability determination based on the image output displayed on the display.

The number-of-times determination device 58 is a device that executes the number-of-times determination step. The number-of-times determination device 58 may include a computer as a device that determines the number of times that it is determined that the image plane is not acceptable in the acceptability determination step. The functions of the number-of-times determination device 58 may be incorporated into the computer of the acceptability determination device 56. In addition, the number-of-times determination device 58 may include a display. In addition, the number of times that it is determined that the image plane is not acceptable may be displayed on the display so that a worker performs determination based on the number displayed on the display.

The changing device 60 is a device that changes the rotation angle of the lens frame 20. The changing device 60 may include a jig, a transport device, a changing robot, or the like as a device that changes the rotation angle of the lens frame 20. The changing device 60 may perform the entire changing work, or the changing device 60 and the worker may perform the changing work in cooperation with each other.

In addition, the changing device 60 may include a computer as a device that derives a target rotation angle with respect to the second non-acceptance. The computer may output a command corresponding to the derived target rotation angle to the changing robot, and the changing robot may change the rotation angle of the lens frame 20 to the target rotation angle based on the command input thereto.

In addition, the changing device 60 may include a display. In addition, the changing device 60 may display the derived target rotation angle on the display, and the worker may perform a changing work based on the target rotation angle displayed on the display.

In addition, the changing device 60 may extract, based on a table or the like, the number of the identification portion 38 corresponding to the target rotation angle which is one of the plurality of identification portions 38 provided at the fixation frame 18 and may display the extracted number on the display. In addition, the worker may perform the changing work based on the number displayed on the display. That is, the changing work may be performed such that the protrusion portion 36 is engaged with the recess portion 34 corresponding to the number. In this case, the worker only needs to perform the changing work based on the number even in a case where the worker does not know the target rotation angle. Therefore, the work efficiency can be improved in comparison with a case where the changing work is performed based on the target rotation angle.

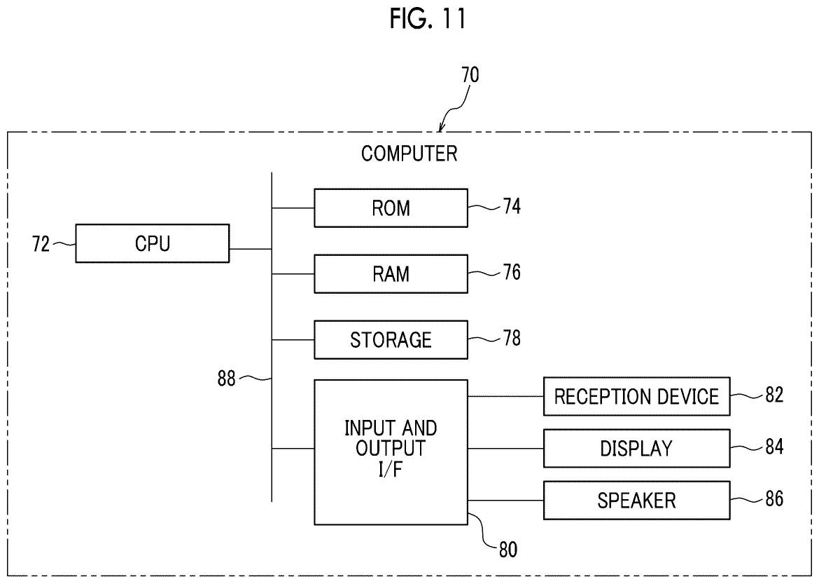

FIG. 11 is a diagram showing a hardware configuration of a computer. A computer 70 shown in FIG. 11 may be applied to each of the computers described above. The computer 70 includes a central processing unit (CPU) 72, a read only memory (ROM) 74, a random access memory (RAM) 76, a storage 78, an input and output interface (I/F) 80, a reception device 82, a display 84, a speaker 86, and a bus 88. The CPU 72, the ROM 74, the RAM 76, the storage 78, and the input and output I/F 80 are connected to each other via the bus 88 such that communication therebetween can be performed.

The reception device 82, the display 84, the speaker 86, and the like are connected to the input and output I/F 80. The reception device 82 includes a mouse, a keyboard, and the like.

The CPU 72 executes various programs. Specifically, the CPU 72 reads out various programs stored in the ROM 74 or the storage 78, and executes the programs using the RAM 76 as a work area. In addition, the CPU 72 performs various types of arithmetic processing in accordance with the programs.

The ROM 74 stores various programs and various data. The RAM 76 temporarily stores a program or data as a work area. The storage 78 is composed of a recording medium such as a hard disk drive (HDD), a solid state drive (SSD), or a flash memory. The storage 78 stores various programs including an operating system and various data for arithmetic processing.

Next, the effects of the present embodiment will be described.

As described above in detail, in the lens device 12 according to the present embodiment, the fixation frame 18 includes the plurality of recess portions 34 arranged in the direction around the optical axis and the lens frame 20 includes the protrusion portion 36 that is selectively engaged with the plurality of recess portions 34. Therefore, it is possible to change the rotation angle of the lens frame 20 with respect to the fixation frame 18 by changing which one of the plurality of recess portions 34 is to be engaged with the protrusion portion 36. Accordingly, the optical characteristics of the lens 22 can be changed.

In addition, for example, optical characteristics related to the lens 22 include, for example, a characteristic related to astigmatism of the lens 22. Examples of the characteristic related to the astigmatism of the lens 22 include image formation performance affected by the astigmatism of the lens 22. Therefore, by changing the rotation angle of the lens frame 20 with respect to the fixation frame 18, it is possible to suppress a decrease in image formation performance caused by the astigmatism of the lens 22.

In addition, the plurality of recess portions 34 are arranged at eight equidistant positions in the direction around the optical axis. Accordingly, the rotation angle of the lens frame 20 can be changed in increments of 45°. Here, according to the Zernike polynomials, the astigmatism of the lens 22 is expressed at pitches of 45° in a circumferential direction of the lens 22. Therefore, by changing the rotation angle of the lens frame 20 in increments of 45°, it is possible to suppress a decrease in image formation performance caused by the astigmatism of the lens 22 in comparison with a case where the rotation angle is not changed.

In addition, the rotation angle of the lens frame 20 can be changed in increments of 45° in accordance with the astigmatism of the lens 22 expressed at pitches of 45°. Accordingly, for example, it is possible to efficiently suppress a decrease in image formation performance in comparison with a configuration in which the rotation angle of the lens frame 20 can be continuously changed.

In addition, the number of the protrusion portions 36 is one. Here, for example, in a case where a plurality of the protrusion portion 36 are formed at the lens frame 20 and the number of the plurality of protrusion portion 36 is the same as the number of the recess portions 34, accuracy is required for intervals between the plurality of protrusion portions 36 for engagement between the protrusion portions 36 and the respective recess portions 34. In this regard, in a case where the number of the protrusion portion 36 is one, the protrusion portion 36 can be easily engaged with the recess portion 34 because accuracy is not required for the intervals between the plurality of protrusion portion 36 unlike a case where the plurality of protrusion portion 36 are formed at the lens frame 20.

Next, modification examples of the present embodiment will be described.

In the above-described embodiment, the fixation frame 18 includes the plurality of recess portions 34 and the lens frame 20 includes one protrusion portion 36. However, the fixation frame 18 may include the plurality of protrusion portions 36 and the lens frame 20 may include one recess portion 34. In this case, the plurality of protrusion portions 36 are examples of “a plurality of engagement portions” in the present disclosed technology, and the one recess portion 34 is an example of “an engagement target portion” in the present disclosed technology.

In addition, in the above-described embodiment, the lens frame 20 includes one protrusion portion 36. However, the number of the protrusion portions 36 may be any number as long as the number of the protrusion portions 36 is a divisor of the number of the plurality of recess portions 34. In this case, the number of the protrusion portion 36 may be smaller than the number of the plurality of recess portions 34.

In addition, in the above-described embodiment, the plurality of recess portions 34 are arranged at eight equidistant positions in the direction around the optical axis. However, the plurality of recess portions 34 may be arranged at equidistant positions without being arranged at eight equidistant positions (for example, may be arranged at four or more and sixteen or less equidistant positions). For example, the plurality of engagement portions may be arranged at sixteen equidistant positions in the direction around the optical axis.

In addition, in the above-described embodiment, the number of the plurality of flanges 28 is smaller than the number of the plurality of screw holes 26. However, the number of the plurality of flanges 28 may be the same as the number of the plurality of screw holes 26.

In addition, in the above-described embodiment, the fixation frame 18 includes the screw holes 26 and the lens frame 20 includes the flanges 28. However, the fixation frame 18 may include the flanges 28 and the lens frame 20 may include the screw holes 26. In this case, the flanges 28 are examples of “a connection portion” in the present disclosed technology, and the screw holes 26 are examples of “a connection target portion” in the present disclosed technology.

In addition, in the above-described embodiment, it is possible to change, as an example of the optical characteristics of the lens 22, the characteristics of the lens 22 related to astigmatism of the lens 22 by changing the rotation angle of the lens frame 20. However, a configuration in which it is possible to change other optical characteristics of the lens 22 may also be adopted.

In addition, in the above-described embodiment, as an example of a characteristic related to astigmatism of the lens 22, a decrease in image formation performance caused by the astigmatism of the lens 22 can be suppressed. However, deterioration in other characteristics related to astigmatism of the lens 22 may be suppressed or the other characteristics may be improved.

In addition, in the above-described embodiment, numbers are provided at the fixation frame 18 as the identification portions 38 corresponding to the respective recess portions 34. However, identifiers other than the numbers may also be provided. In addition, rotation angles corresponding to the respective recess portions 34 may be written on the fixation frame 18 instead of the numbers. The identifiers or the rotation angles provided instead of the plurality of numbers are examples of “an identification portion” in the present disclosed technology.

In addition, in the manufacturing method of the lens device 12 according to the present embodiment, the adjustment step of adjusting the positions of the plurality of lenses is executed before the changing step of changing the rotation angle of the lens frame 20. However, the adjustment step may be executed after the changing step.

In addition, among the above-described modification examples, modification examples that can be combined with each other may be combined with each other as appropriate.

Note that as a hardware resource applied to the computer 70, various processors described below can be used. Examples of the processor include a CPU which is a general-purpose processor functioning as the hardware resource by executing software, that is, a program. Further, examples of the processor include a dedicated electric circuit that is a processor having a circuit configuration dedicatedly designed to execute specific processing, such as a field programmable gate array (FPGA), a programmable logic device (PLD), or an application specific integrated circuit (ASIC). A memory is built in or connected to any processor, and any processor executes each processing by using the memory.

The hardware resource may be composed of one of these various processors, or may be composed of a combination (for example, a combination of a plurality of FPGAs or a combination of a CPU and an FPGA) of the same types or different types of two or more processors. Moreover, the hardware resource for execution of each processing may be one processor.

As an example of a configuration with one processor, first, there is an example in which one processor is composed of a combination of one or more CPUs and software and the processor functions as the hardware resource for execution of each processing. Secondly, as typified by a system-on-a-chip (SoC), there is an example in which a processor that realizes, with one IC chip, the functions of the entire system including a plurality of hardware resources for execution of each processing is used. As described above, each processing is realized by using one or more of various processors as the hardware resource.

As a hardware structure of these various processors, more specifically, an electrical circuit in which circuit elements such as semiconductor elements are combined can be used. In addition, each of the above-described processes is merely an example. Therefore, it is a matter of course that an unnecessary step may be deleted, a new step may be added, and the order in which processes are performed may be changed without departing from the spirit.

Contents described and illustrated above are for detailed description of a part according to the present disclosed technology and are merely an example of the present disclosed technology. For example, description of the above-described configurations, functions, actions, and effects is description related to an example of configurations, functions, actions, and effects of a part according to the present disclosed technology. Therefore, it is a matter of course that an unnecessary part of the contents described and illustrated above may be deleted, a new element may be added, and replacement may be made without departing from the spirit of the present disclosed technology. In addition, in order to avoid complication and facilitate the understanding of a portion according to the present disclosed technology, regarding the contents described and illustrated above, description related to common technical knowledge or the like which does not need to be described to enable implementation of the present disclosed technology has been omitted.

All publications, patent applications, and technical standards described in the present specification are incorporated herein by reference to the same extent as if each publication, patent application, or technical standard was specifically and individually indicated to be incorporated by reference.

### EXPLANATION OF REFERENCES

What is claimed is:

1. A lens device comprising:
a fixation frame; and
a lens frame that holds lenses and that is fixed to the fixation frame,
wherein the fixation frame includes a plurality of engagement portions that are arranged in a direction around an optical axis, and
the lens frame includes an engagement target portion that is selectively engaged with the plurality of engagement portions.

2. The lens device according to claim 1,
wherein a rotation angle of the lens frame with respect to the fixation frame is changeable by changing which one of the plurality of engagement portions is to be engaged with the engagement target portion.

3. The lens device according to claim 2,
wherein optical characteristics of the lenses are changeable by changing the rotation angle.

4. The lens device according to claim 3,
wherein the optical characteristics include a characteristic related to astigmatism of the lenses.

5. The lens device according to claim 1,
wherein the lenses include a lens that is a part of a plurality of lenses of the lens device and that is disposed on an object side.

6. The lens device according to claim 1,
wherein the plurality of engagement portions are arranged at four or more and sixteen or less equidistant positions in the direction around the optical axis.

7. The lens device according to claim 6,
wherein the plurality of engagement portions are arranged at eight equidistant positions.

8. The lens device according to claim 1,
wherein the number of the engagement target portions is smaller than the number of the plurality of engagement portions.

9. The lens device according to claim 1,
wherein the number of the engagement target portions is one.

10. The lens device according to claim 1,
wherein the fixation frame includes an identification portion for identification of a position of engagement between the engagement target portion and the engagement portions.

11. The lens device according to claim 10,
wherein a plurality of the identification portions include symbols arranged in the direction around the optical axis.

12. The lens device according to claim 10,
wherein a plurality of the identification portions are provided on a side surface portion of the fixation frame.

13. The lens device according to claim 1,
wherein the fixation frame includes a fixation portion to which the lens frame is fixed, and
the plurality of engagement portions are formed at the fixation portion.

14. The lens device according to claim 13,
wherein the fixation portion is provided at an end portion of the fixation frame that is on one side in an axial direction of the fixation frame.

15. The lens device according to claim 1,
wherein each of the engagement portions is a recess portion, and
the engagement target portion is a protrusion portion.

16. The lens device according to claim 15,
wherein the recess portion is formed in a recessed shape that is open on a radially inner side with respect to the fixation frame.

17. The lens device according to claim 15,
wherein the protrusion portion is formed in a protruding shape that protrudes toward a radially outer side with respect to the lens frame.

18. The lens device according to claim 15,
wherein the recess portion is open on one side in an axial direction of the fixation frame.

19. The lens device according to claim 15,
wherein the protrusion portion is formed on an outer peripheral portion of the lens frame.

20. The lens device according to claim 15,
wherein the lens frame includes a rib that is provided to be adjacent to the protrusion portion in an optical axis direction.

21. The lens device according to claim 1,
wherein the fixation frame includes a connection portion, and
the lens frame includes a connection target portion that is connected to the connection portion.

22. A manufacturing method of a lens device including a fixation frame and a lens frame that holds lenses and that is fixed to the fixation frame, the fixation frame including a plurality of engagement portions that are arranged in a direction around an optical axis, the lens frame including an engagement target portion that is selectively engaged with the plurality of engagement portions, the manufacturing method comprising:
a changing step of changing a rotation angle of the lens frame with respect to the fixation frame by changing which one of the plurality of engagement portions is to be engaged with the engagement target portion.

23. The manufacturing method of a lens device according to claim 22,
wherein the fixation frame includes an identification portion for identification of a position of engagement between the engagement portions and the engagement target portion, and
one of a plurality of the identification portions that corresponds to a target rotation angle is extracted in the changing step.
